(19) United States
(12) Patent Application Publication
(10) Pub. No.: US 2022/0414759 A1
(43) Pub. Date: Dec. 29, 2022

(54) AGRICULTURAL PRODUCTS TRADING SYSTEM BASED ON REAL-TIME RELAY OF CULTIVATION PROCESS

(71) Applicant: GLOBAL CODING RESEARCH CO., LTD, Changwon-si, Gyeongsangnam-do (KR)

(72) Inventor: Chang Hun LEE, Changwon-si Gyeongsangnam-do (KR)

(73) Assignee: GLOBAL CODING RESEARCH CO., LTD, Changwon-si, Gyeongsangnam-do (KR)

(21) Appl. No.: 17/780,510

(22) PCT Filed: Dec. 6, 2019
(86) PCT No.: PCT/KR2019/017168

§ 371 Date: May 26, 2022

(51) Int. Cl. G06Q 30/08; G06Q 50/02; G06Q 10/02; G06Q 30/02; G06V 20/10

(52) U.S. Cl. CPC G06Q 30/08; G06Q 50/02; G06Q 10/02; G06Q 30/0283; G06V 20/188

(57) ABSTRACT

The present invention relates to a sales system that can increase transparency in cultivation by disclosing various situations occurring in the cultivation process to consumers, comprising: a crop image server that receives and stores images of crop grown in a crop production area; a reservation server that posts sales information of the crop using the images of crop stored in the crop image server and receives presale orders for the crop from a buyer terminal; a growth image transmission server that transmits the images of the reserved crop to the buyer terminal; and a pricing server that calculates the expected yield in consideration of risks that may occur in the process of growing the crop and calculates the unit price of the crop.

### TECHNICAL FIELD

The present invention relates to an agricultural products trading system based on real-time relay of cultivation process, and more specifically, to a trading system that increases the transparency in cultivation by disclosing various situations occurring in the cultivation process to consumers.

### BACKGROUND ART

In general, direct trade of agricultural products on the Internet are structured so that sellers can take and upload images of agricultural products to be sold on the website, and consumers can buy agricultural products after viewing the images.

As such direct trade of agricultural products omits the distribution stage, sellers and consumers can trade agricultural products at reasonable prices, and the number of people using direct trade is increasing.

However, the conventional direct trade of agricultural products has a structure in which consumers have no choice but to trust sellers and make transactions because consumers cannot check the cultivation environment and cultivation process of crops.

In addition, when the demand for agricultural products exceeds the supply, the price rises excessively and acts as a burden on consumers. Conversely, if agricultural products are overproduced, they are not harvested or sold at a low price, resulting in a loss to sellers.

Accordingly, there is a problem in that sellers grow crops with a burden on demand forecasting.

Therefore, there is an increasing demand for the direct trade of agricultural products that allows sellers to receive pre-orders at the time of planning the cultivation by providing the cultivation place, sowing time, flowering time, expected yield, etc. according to the cultivation plan of crops and grow reserved crops while disclosing such processes via SNS (Social Networking Service), etc.

### SUMMARY OF INVENTION

### Technical Problem

The present invention aims to provide an agricultural products trading system based on real-time relay of cultivation process that increases the transparency in cultivation by disclosing various situations occurring in the cultivation process to consumers.

### Solution to Problem

In order to achieve the above purpose, an agricultural products trading system based on real-time relay of cultivation process according to an embodiment of the present invention comprises: a crop image server that receives and stores images of crop grown in a crop production area; a reservation server that posts sales information of the crop using the images of crop stored in the crop image server and receives presale orders for the crop from a buyer terminal; a growth image transmission server that transmits the images of the reserved crop to the buyer terminal; and a pricing server that calculates the expected yield in consideration of risks that may occur in the process of growing the crop and calculates the unit price of the crop.

In this case, the crop image server may comprise a crop sameness determination unit that compares images of crops by date and determines whether the crop image received on a specific day is the same as the initially received image of the crop.

At this time, the pricing server may comprise a yield calculator for calculating the expected yield of the crop, which calculates the expected yield of the crop by analyzing the images of the crop by date, received by the crop image server.

Also, the crop image server may further comprise a standard image recorder for storing the average growth images of the crop, which can compare the images of the crop by date, received by the crop image server, with the average growth images stored in the standard image recorder, and calculate the expected yield based on the degree of similarity.

In addition, the crop image server may receive crop images photographed by a dedicated application installed in the mobile terminal of a producer who produces the crop.

Here, the dedicated application may classify and acquire images of the specific crop by continuously shooting video in units of rows or furrows where crops are grown, and extracting images of individual crops from the captured images.

Meanwhile, the growth image transmission server may select and edit the images by date of the reserved crops, from a plurality of images of crops stored in the crop image server, and transmit them to the terminal of the buyer who made a purchase reservation.

### Beneficial Effects

An agricultural products trading system based on real-time relay of cultivation process according to the present invention has the following effects.

First, information such as cultivation place, sowing time, flowering time, and expected yield according to the cultivation plan is provided so that the seller can predict the demand for crops and prevent overproduction by receiving pre-orders at the time of planning the cultivation.

Second, trust between sellers and consumers is formed because the environment and process in which crops are grown are provided to consumers in real time.

### BRIEF DESCRIPTION OF DRAWINGS

FIG. 1 is a block diagram illustrating that buyers and producers are connected through an agricultural products trading system based on real-time relay of cultivation process according to the present invention.

FIG. 2 is a detailed block diagram of the agricultural products trading system shown in FIG. 1.

FIG. 3 is a diagram explaining a method of acquiring images of a crop from a producer terminal.

### BEST MODE FOR CARRYING OUT THE INVENTION

Hereinafter, preferred embodiments of the present invention will be described in detail with reference to the accompanying drawings. In this case, it should be noted that in the accompanying drawings, the same components are denoted by the same reference numerals as much as possible. In addition, detailed descriptions of well-known functions and configurations that may obscure the gist of the present invention will be omitted. For the same reason, some components are exaggerated, omitted, or schematically illustrated in the accompanying drawings.

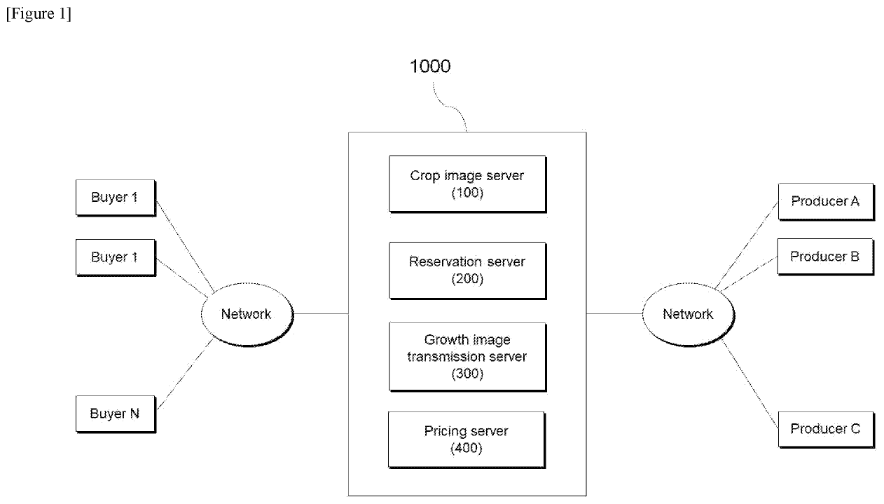

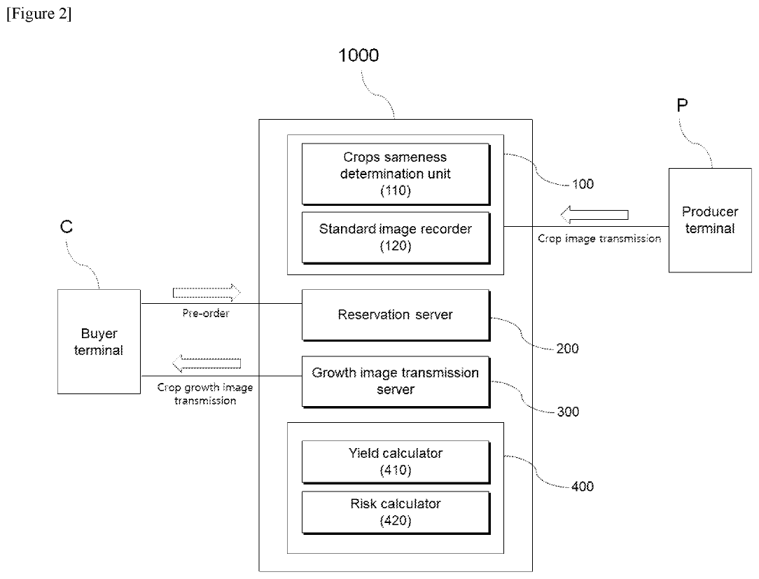

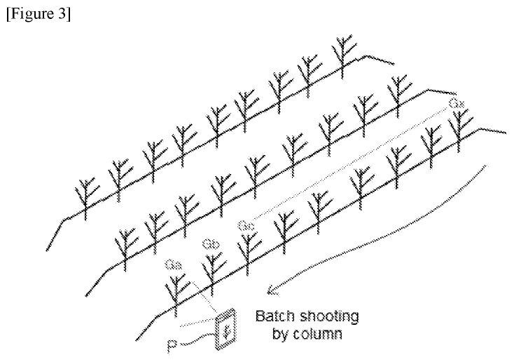

FIG. 1 is a block diagram illustrating that buyers and producers are connected through an agricultural products trading system based on real-time relay of cultivation process according to the present invention, and FIG. 2 is a detailed block diagram of the agricultural products trading system shown in FIG. 1, and FIG. 3 is a diagram for explaining a method of acquiring crop images from a producer terminal.

Referring to FIG. 1 to FIG. 3, an agricultural products trading system based on real-time relay of cultivation process (1000) according to the present invention comprises a crop image server (100), a reservation server (200), a growth image transmission server (300) and a pricing server (400).

The agricultural products trading system (1000) of the present invention is a system that brokers trade of crops produced by a plurality of producers (Producer A, Producer B, . . . Producer N).

Before describing each configuration in detail, the crop trading process between buyers and producers in the agricultural products trading system (1000) will be briefly described.

A plurality of producers (Producer A, Producer B, . . . Producer N) access the agricultural products trading system (1000) via a wired or wireless network (eg, a network for Internet connection), and post the crops they produce on the agricultural products trading system (1000).

Buyers (buyer1, buyer 2, . . . buyer N) access the agricultural products trading system (1000) via a wired or wireless network (eg, a network for Internet connection), and reserve the purchase of desired crops among the crops posted by the producers.

For example, if buyer 1 has reserved the purchase of crops from producer A, producer A uses the producer terminal (P) to take picture of the purchased crop every day (or at a specific cycle) and sends (ie, uploads) the images from the first day of cultivation to the expected date of harvest to the crop image server (100).

The growth image transmission server (300) transmits the uploaded images by date to the terminal (C) of buyer A as they are or through a predetermined editing process.

When the reserved crops are grown and begin to be harvested, producer A sends the harvested crops to buyer 1 to complete the trade process.

Next, each configuration will be described in detail.

The crop image server (100) receives and stores images of crops grown in crop production areas. The crop image server (100) comprises a storage for storing crop images, but the storage is not shown because it is a self-evident configuration.

According to an embodiment, the crop image server (100) may include a crops sameness determination unit (110) and a standard image recorder (120).

The crops sameness determination unit (110) compares the received crop images for each date and determines whether the crop images received on a specific day are the same as the initially received crop images.

As crops gradually change in size and shape during the growing process, the crops sameness determination unit (110) compares the received images by date and examines the similarity to determine whether the received crop images are of the same crop.

The crops sameness determination unit (110) may be used to prevent reserved crops from being replaced with the same kind of crops produced by another producer.

Meanwhile, the standard image recorder (120) stores the average growth image of a crop. The average growth image corresponds to an image obtained by collecting all images of a crop that producer A has grown previously.

More specifically, if it is assumed that producer A grows mushrooms, for example, the crop image server (100) stores all the images for each date taken by producer A during the first, the second, and the Nth cultivation of mushrooms.

According to an embodiment, the standard image recorder (120) extracts the size of crops for each day from the 1st to Nth images, and may select an image of a crop having an average size as a standard image (ie, an average growth image).

“Average growth image” may be used in the yield calculator (410) to be described later.

The reservation server (200) uses the crop images stored in the crop image server (100) to publish sales information of the crop, and receives pre-orders for the crop from the buyer terminal (C).

The configuration of the reservation server (200) is similar to that of a typical online shopping mall, so a detailed description thereof will be omitted.

The growth image transmission server (300) transmits the images of the crop reserved for purchase to the terminal (C) of the buyer who has reserved the purchase. At this time, the images of the crop reserved for purchase may be directly transmitted from the producer terminal (P) to the buyer terminal (C), but a predetermined image processing may be performed to further increase the reliability of the crop cultivation process.

As an example, the growth image transmission server (300) may edit and transmit images of crops reserved for purchase by date, among a plurality of images of crops stored in the crop image server, to the buyer terminal (C) that has made a purchase reservation.

The pricing server (400) reflects risks that may occur in the process of growing crops to calculate the expected yield, and calculates the unit price of the crop. As growth conditions may change depending on weather conditions in the process of growing crops, crop yields may change depending on conditions such as the germination success rate of crops.

The risks may be applied only to a specific producer (eg, Producer A), or may be applied to all producers (eg, Producer A to Producer C).

According to an embodiment, the pricing server (400) may include a yield calculator (410) and a risk calculator (420).

The yield calculator (410) calculates the expected yield of the crop, and more specifically, analyzes the images by date of the crop received by the crop image server to calculate the expected yield of the crop. For example, the images by date of the crop, received from the crop image server, are compared with the average growth image stored in the standard image recorder (120) to calculate the expected yield based on the similarity between the two sides.

The risk calculator (420) adjusts the initial selling price posted on the reservation server (200) based on the expected yield for each producer (producer A, producer B, and producer C) calculated by the yield calculator (410). At this time, whether to change or maintain the contract price of buyer 1 who made a purchase reservation may change depending on risk settings.

Hereinafter, a detailed operation of uploading crop images to the crop image server (100) will be described.

In order to increase the reliability of the crop image, the crop image server (100) is set to receive the images of the crop photographed by a dedicated application installed on the mobile terminal (ie, the producer terminal (P)) of the producer who produces the crop.

Here, the dedicated application is installed on the producer terminal (P). The dedicated application can access the agricultural products trading system (1000) after user authentication.

Referring to FIG. 3, the dedicated application shoots a video of crops collectively in units of rows or furrows, and acquires images of a specific crop by extracting images of an individual crop from the captured video.

It is very cumbersome for producers to separate and photograph individual crops (Ga, Gb, Gc . . . Gx) one by one. When a producer runs a dedicated application to record a video of crops (Ga, Gb, Gc . . . Gx) in rows or furrows while moving,

the dedicated application processes the video and extract individual images of each crop. Then, the crop image extracted as an individual image is uploaded to the crop image server (100).

Although not illustrated, it may be preferable to mark numbers or letters in the rows where crops (Ga, Gb, Gc . . . Gx) are grown in order to assist in processing such images. Moreover, in order to clearly check the growth process of crops, it is preferable to provide a stick as a marker so that the relative size of crops can be confirmed.

The embodiments of the present invention, disclosed in the present specification and drawings, are merely provided for specific examples to easily explain the technical contents of the present invention and help the understanding of the present invention, and are not intended to limit the scope of the present invention. It will be apparent to those of ordinary skill in the art to which the present invention pertains that other modifications based on the technical spirit of the present invention can be implemented in addition to the embodiments disclosed herein.

1000: agricultural products trading system

100: crop image server

200: reservation server

300: growth image transmission server

400: pricing server

1. An agricultural products trading system based on real-time relay of cultivation process that comprises:
a crop image server that receives and stores images of crop grown in a crop production area;
a reservation server that posts sales information of the crop using the images of crop stored in the crop image server and receives presale orders for the crop from a buyer terminal;
a growth image transmission server that transmits the images of the reserved crop to the buyer terminal; and
a pricing server that calculates the expected yield in consideration of risks that may occur in the process of growing the crop and calculates the unit price of the crop.

2. With respect to claim 1,
an agricultural products trading system based on real-time relay of cultivation process,
wherein the crop image server may comprise a crop sameness determination unit that compares images of crops by date and determines whether the crop image received on a specific day is the same as the initially received image of the crop.

3. With respect to claim 2,
an agricultural products trading system based on real-time relay of cultivation process,
wherein the pricing server may comprise a yield calculator for calculating the expected yield of the crop, which calculates the expected yield of the crop by analyzing the images of the crop by date, received by the crop image server.

4. With respect to claim 3,
an agricultural products trading system based on real-time relay of cultivation process,
wherein the crop image server may further comprise a standard image recorder for storing the average growth images of the crop, which may compare the images of the crop by date, received by the crop image server, with the average growth images stored in the standard image recorder, and calculate the expected yield based on the degree of similarity.

5. With respect to claim 1,
an agricultural products trading system based on real-time relay of cultivation process,
wherein the crop image server may receive crop images photographed by a dedicated application installed in the mobile terminal of a producer who produces the crop.

6. With respect to claim 5,
an agricultural products trading system based on real-time relay of cultivation process,
wherein the dedicated application may classify and acquire images of the specific crop by continuously shooting video in units of rows or furrows where crops are grown, and extracting images of individual crops from the captured images.

7. With respect to claim 1,
an agricultural products trading system based on real-time relay of cultivation process,
wherein the growth image transmission server may select and edit the images of the reserved crops by date, from a plurality of images of crops stored in the crop image server, and transmit them to the terminal of the buyer who made a purchase reservation.
